(19) United States
(12) Patent Application Publication
(10) Pub. No.: US 2025/0347266 A1
(43) Pub. Date: Nov. 13, 2025

(54) WIND TURBINE TOWER NON-INTERFERENCE STACKABLE SYSTEM

(71) Applicant: CLS WIND LLC, Houston, TX (US)

(72) Inventors: Andres C. Garcia, Missouri City, TX (US); Kent A. Johnson, Houston, TX (US)

(21) Appl. No.: 18/992,982

(22) PCT Filed: Jul. 13, 2023
(86) PCT No.: PCT/US2023/027689

§ 371 Date: Jan. 10, 2025

Related U.S. Application Data
(60) Provisional application No. 63/389,390, filed on Jul. 15, 2022.

(51) Int. Cl. F03D 13/10; E04H 12/08; E04H 12/34; F03D 13/20

(52) U.S. Cl. CPC F03D 13/112; F03D 13/205; E04H 12/085; E04H 12/342; F05B 2230/60

(57) ABSTRACT

A tower assembly system can include OEM supplied tower sections and intermediate flange(s) that facilitate the lifting of the tower sections over a previous section without the use of conventional overhead lifting systems. A method and system for assembling a wind turbine can involve placing intermediate flanges on the top and bottom of each section without permanently modifying existing components or using OEM supplied connection points.

### CROSS REFERENCE TO PATENT APPLICATION

This patent application claims priority to International Patent Application No. PCT/US23/27689 entitled “Wind Turbine Tower Non-Interference Stackable System,” which was filed on Jul. 13, 2023, and is incorporated herein by reference in its entirety. International Patent Application No. PCT/US23/27689 claims priority under the PCT (Patent Cooperation Treaty) to U.S. Provisional Patent Application Ser. No. 63/389,390 entitled “Wind Turbine Tower Non-Interference Stackable System,” which was filed on Jul. 15, 2022, and is also incorporated herein by reference in its entirety.

### TECHNICAL FIELD

Embodiments are related to devices, methods, and systems for assembling towers including, but not limited to wind turbine towers. Embodiments further relate to a method of stacking or installing the tower sections over the previous section by using a lower-supported towers lift, rather than the typical overhead lift used in other systems, such as those utilizing conventional cranes.

### BACKGROUND

Wind power is considered one of the cleanest, most environmentally friendly energy sources presently available, and wind turbines have gained increased attention in this regard. Wind turbines are used to convert kinetic energy of wind into electrical power. A modern wind turbine typically includes a tower, a generator, a gearbox, a nacelle, and one or more rotor blades. The rotor blades capture kinetic energy from wind using known airfoil principles and transmit the kinetic energy through rotational energy to turn a main shaft coupling the rotor blades to a gearbox, or if a gearbox is not used, directly to the generator. The generator then converts the mechanical energy to electrical energy that may be deployed to a utility grid, stored or used for other local means. A wind turbine typically includes a substantially large sized rotor (i.e., wheel) coupled to the nacelle disposed on top end of a tower. The nacelle includes a generator for producing electrical power from rotary motion energy produced by the rotor.

Conventionally, installation, repair, repowering and decommissioning of such wind turbines requires at least one large sized crane system, which may need to be robust enough for reaching and lifting heavy loads to considerable heights while installing, repairing, repowering or decommissioning the wind turbine. The wind turbine may generally extend several tens of meters above ground level or sea level. Typically, such large sized crane systems are scarce and expensive to mobilize, setup and install at a wind turbine site.

Wind turbine installation for such large sized power capacity systems may involve traditional crane installation techniques or so-called ‘craneless’ approaches, such as “climbing type” crane adaptations and/or tower-type cranes used for wind turbine installations, erected next to a wind turbine tower.

Wind turbine installation for such large sized power capacity systems may involve traditional crane installation techniques or so-called ‘craneless’ approaches. FIG. 1A, for example, depicts an image of a traditional crane installation approach. FIG. 1B, on the other hand, shows a craneless approach involving a tower grab system. An example of such a tower grab system is disclosed in U.S. Pat. No. 10,494,235, which is incorporated herein by reference in its entirety.

Another example of a craneless approach is shown in FIG. 1C, which illustrates a tower crane type application used for wind turbine installations, next to a wind turbine tower. Another example of a craneless installation technique can involve the use of a tower crane that runs a climbing tower with modified wind turbine power. A further example of a craneless system involves the use of a rail on a tower with either a conveyor or a crane on a carriage. An example of this approach is disclosed in U.S. Pat. No. 9,261,072, which is incorporated herein by reference in its entirety.

FIG. 1D illustrates an image of a prior art system for raising a tower section. FIG. 1E illustrates a pictorial diagram of another prior art system for assembling tower sections for a wind tower.

With the increase in height and weight of wind turbines and related components, the need for large size, heavy lift cranes (onshore) and (offshore) heavy- lift or wind turbine installation vessels (WTIV) are ever more present. There is not enough of this large size equipment to supply the world with installation or repair capacity, and this will cause bottlenecks and delays in many wind farm projects.

In addition, both the costs and time that takes to install this equipment is very high and extensive. There are better installation methods that would allow for parallel installations, saving time and cost to the end user/owner.

Environmental damage and carbon emission reductions are also issues of great public interest. Our system also aims to reduce the environmental footprint by minimizing the area utilized and civil work required at the wind turbine site, as well as the access roads, by using the smallest possible cranes and as few transport loads as possible.

Operational weather windows are also short, especially in northern locations with colder weather, and having the ability to extend the operational window will allow for more efficient operations and time savings.

In addition, there are many areas of the world that do not have either the resources or the capacity to obtain this large, heavy equipment, but where it is desired to install large capacity wind turbines. This goal may be unable to be achieved, however, due to the scarcity of installation resources. The present inventors thus propose a solution to the above problems that aims to allow any country, company, or person, to install any wind turbine capacity and size that is desired, utilizing existing, small or medium capacity cranes and fewer resources.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, an aspect of the embodiments to provide for improved wind turbine installation methods and systems.

It is another aspect of the embodiments to provide for methods and systems for stacking or installing tower sections over a previous section by using a lower supported towers lift, rather than an overhead lift as used in conventional systems.

It is a further aspect of the embodiments to provide a window tower assembly method and system which uses OEM (Original Equipment Manufacturer) provided tower sections with adding of an intermediate flange (or flanges) on the top and bottom of each tower section without permanently modifying existing components or using an OEM existing connection point.

It is also an aspect of the embodiments to provide for flanges with indentations of variable shaped holes that can allow for the handling of the weight into position and the ability to remove the lifting system without having any pinch points, at any time.

It is a further aspect of the embodiments to provide a configuration for use with the aforementioned flanges, which can become an integral part of the original tower flanges, to minimize parts.

It is also an aspect of the embodiments to provide for a configuration that can be used in assemblies using external or internal elevators or lifting systems.

It is a further aspect of the embodiments to provide for a tower assembly system that can include an attachment of lifting points in the upper part of the flange(s) as well.

The aforementioned aspects and other objectives and advantages can now be achieved as described herein. In an embodiment, a method of assembling a wind tower, can involve: providing a plurality of tower sections for a wind tower, wherein the plurality of tower sections includes a tower section and a previous tower section; and stacking the tower section over the previous tower section using at least one lower supported tower lift.

An embodiment can further involve adding at least one intermediate flange among a plurality of flanges at a top and a bottom of each tower section among the plurality of tower sections without permanently modifying existing components of the wind tower or using an OEM existing connection point.

In an embodiment, at least one flange among the plurality of flanges can be configured with indentations of variable shaped holes that can facilitate the handling of a weight into position and removal of a lifting system without pinch points.

An embodiment can further involve providing a plurality of flanges of different diameters and shapes, as well as different hole diameters and hole shapes that can facilitate lifting of the plurality of flanges.

An embodiment can further involve providing a configuration used in at least one flange among the plurality of flanges that becomes an integral part of original tower flanges for minimizing parts.

An embodiment can further involve using the configuration in assemblies with an external elevator, an internal elevator or a lifting system.

In an embodiment, a system for assembling a wind tower, can include: a plurality of tower sections for a wind tower, wherein the plurality of tower sections includes a tower section and a previous tower section, and at least one lower supported tower lift for stacking the tower section over the previous tower section using the at least one lower supported tower lift.

In an embodiment, at least one intermediate flange can be added at the top and the bottom of each tower section among the plurality of tower sections without permanently modifying existing components of the wind tower or using an OEM existing connection point.

In an embodiment, at least one flange can include indentations of variable shaped holes that facilitates handling of a weight into position and a removal of a lifting system without pinch points.

An embodiment can further include a plurality of flanges of different diameters and shapes, as well as different hole diameters and hole shapes that can assist in facilitating lifting of the plurality of flanges.

An embodiment can further include a configuration used in at least one flange among the plurality of flanges that can become an integral part of original tower flanges for minimizing parts.

In an embodiment, the configuration can be adapted for use in assemblies using an external elevator, an internal elevator, or a lifting system.

In an embodiment, a system for assembling a wind tower, can include: a plurality of tower sections for a wind tower, wherein the plurality of tower sections includes a tower section and a previous tower section; at least one lower supported tower lift for stacking the tower section over the previous tower section using the at least one lower supported tower lift; and a plurality of flanges.

In an embodiment, the plurality of flanges can include at least one intermediate flange.

In an embodiment, the at least one intermediate flange can be added at a top and a bottom of each tower section among the plurality of tower sections without permanently modifying existing components of the wind tower or using an OEM existing connection point.

In an embodiment, the plurality of flanges can include at least one flange comprising indentations of variable shaped holes that allow for a handling of a weight into position and for removal of a lifting system without pinch points.

In an embodiment, the plurality of flanges can include flanges of different diameters and shapes.

In an embodiment, the plurality of flanges can further include different hole diameters and hole shapes to facilitate lifting of the plurality of flanges.

In an embodiment, the plurality of tower sections of the wind tower further can include an intermediate tower section located between the tower section and the previous tower section.

In an embodiment, the plurality of flanges can include one or more of: a Bottom Support Flange (BSF) and a Top Support Flange (TSF).

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1A illustrates a diagram of a prior art crane installation system;

FIG. 1B illustrates an image of a craneless prior art grab system;

FIG. 1C illustrates an image of a craneless prior art system having a tower crane that is run next to a wind turbine;

FIG. 1D illustrates an image of a prior art system for raising a tower section;

FIG. 1E illustrates a pictorial diagram of another prior art system for assembling tower sections for a wind tower;

FIG. 2 illustrates a schematic diagram of a tower base including non- interference flange systems, in accordance with an embodiment;

FIGS. 3A-3B illustrates schematic diagrams of a tower intermediate flange (multiple or single) system for unmodified OEM Tower sections, in accordance with an embodiment;

FIG. 4 illustrates a schematic diagram of a tower intermediate flange system with non-interference loading supports (with multiple or single), in accordance with an embodiment;

FIG. 5 illustrates a schematic diagram of a tower intermediate flange system with non-interference loading supports (with multiple or single), in accordance with an embodiment;

FIG. 6 illustrates a schematic diagram of tower intermediate flange system with non-interference loading supports (with multiple or single), in accordance with an embodiment; and

FIG. 7 illustrates a schematic diagram of a side view of a complete tower, in accordance with an embodiment.

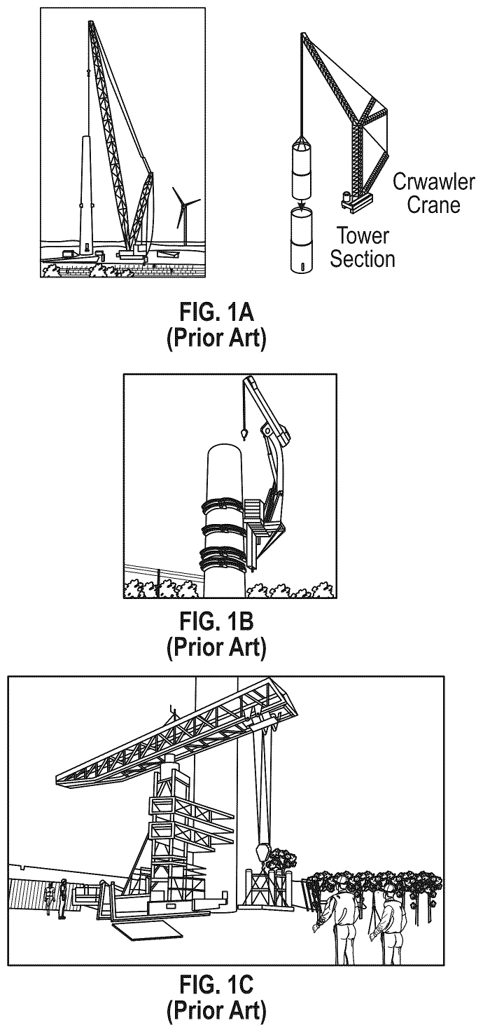

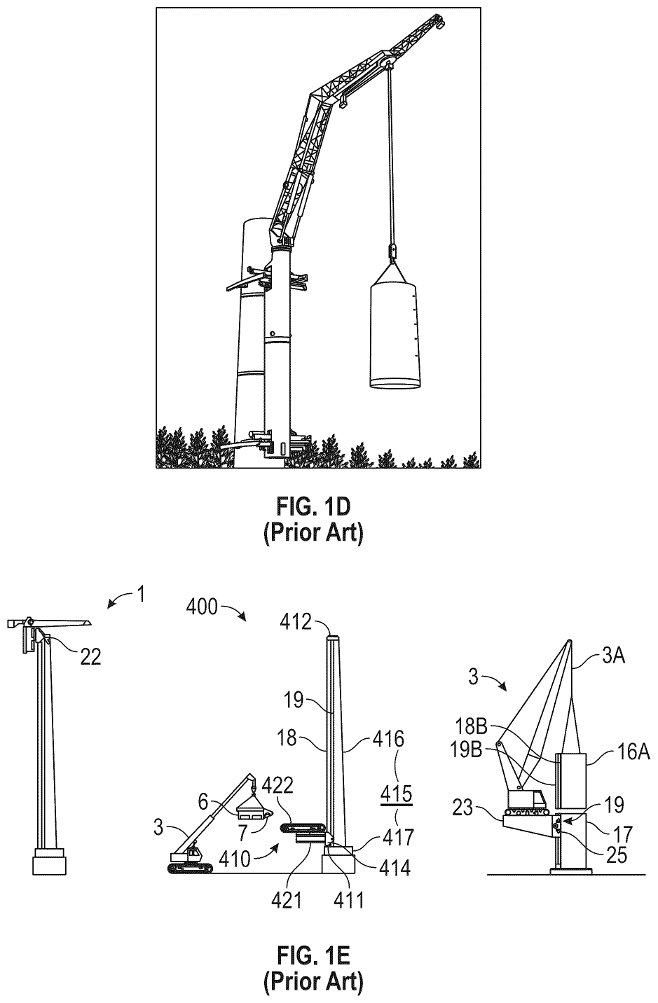

Like reference numerals utilized herein can refer to identical or similar parts or elements.

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context.

In addition, the term “based on” may be understood as not necessarily intended to convey an exclusive set of factors and may, instead, allow for existence of additional factors not necessarily expressly described, again, depending at least in part on context. Furthermore, the phrase “at least one” may be understood to convey the meaning “one or more”. For example, “at least one widget” may convey the concept of “one or more widgets”.

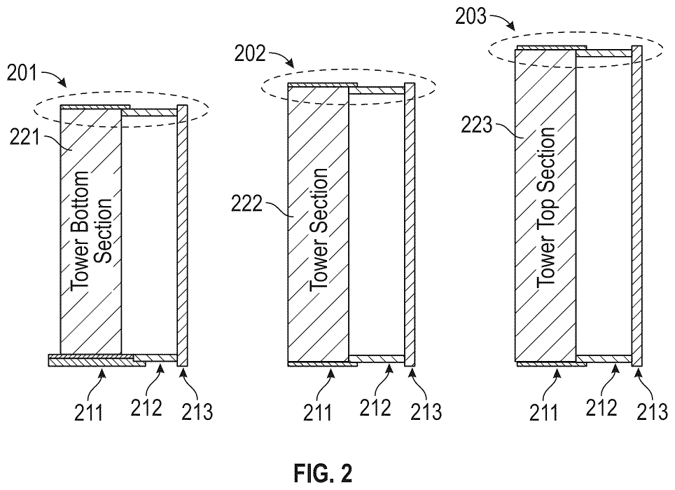

FIG. 2 illustrates a schematic diagram of a group of tower sections for use in assembly or installing a wind tower, in accordance with an embodiment. The group of tower section shown in FIG. 2 include a tower bottom section 221, a tower section 222, and a tower top section 223. The configuration shown in FIG. 2 includes a non- interference flange system 201, a non-interference flange system 202, and a non- interference flange system 203, which are each indicated by the circular dashed lines shown in FIG. 2. Note that the circular dashed lines have a corresponding system with similar or different dimensions on the bottom, as can be required to match the OEM flange dimensions.

Wind tower assembly can be achieved by utilizing OEM provided tower sections (tower bottom section 221, tower section 222, tower top section 223) and adding an intermediate flange (or flanges) on the top and bottom of each tower section without permanently modifying existing components or using an OEM existing connection point. Each non-interference flange system includes one or more flanges such as, for example, flange portion 211, interconnector portion 212, and a rack/guide portion 213. These flanges can be configured with indentations of variable shaped holes that can allow for the handling of the weight into position and the ability to remove the lifting system without having any pinch points, at any time.

Note that the term “flange” as utilized herein and in the context of the assembly of wind tower sections for a wind tower that supports a wind turbine can refer to a component that plays a significant role in joining different sections of the tower together. A flange can be a flat, circular or ring-shaped disc or other configuration or shape as discussed herein. It may be configured from steel or other durable materials capable of withstanding the loads and forces experienced by the wind tower. A flange can provide a secure and rigid connection between adjacent tower sections, ensuring structural integrity and stability. Each tower section may have a corresponding flange at its end, and when two sections are assembled, their flanges can be aligned and bolted together using high-strength fasteners such as bolts. The flange design can be carefully engineered to distribute the load and stresses evenly across the joint, enhancing the overall strength and stability of the wind tower.

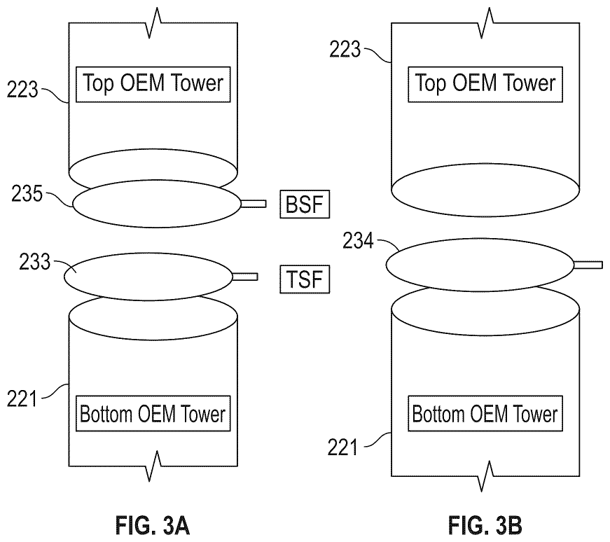

FIGS. 3A-3B illustrates schematic diagrams of a tower intermediate flange (multiple or single) system for unmodified OEM Tower sections, in accordance with an embodiment. In FIG. 3A, the Bottom Support Flange (BSF) 235 is an insert that is located at the bottom of the top OEM tower section 223 and will fit the design of the top OEM tower 223 original flange, and also allow for connection to/from the rack. The Top Support Flange (TSF) 233 can be provided as an insert that can be located at the top of the lower tower OEM section 221, and which can fit the design of the lower OEM tower section 221 original flange and can further allow for connection to/from the rack. For FIG. 3B, the flange insert 234 can be a single insert unit that can consist of both a BSF and TSF together.

Note that the term BSF or “Bottom Support Flange” as utilized herein can relate to a type of flange that can be used in the assembly of wind tower sections for supporting a wind turbine. The BSF can be located at the base or bottommost section of the wind tower, thereby providing a connection point between the wind tower and its foundation. The BSF can serve as an interface between the wind tower and the foundation, distributing the loads and forces from the wind turbine and the tower itself into the foundation system. It can be designed to transfer the weight of the tower and the rotational forces generated by the wind turbine to the ground, ensuring stability and structural integrity.

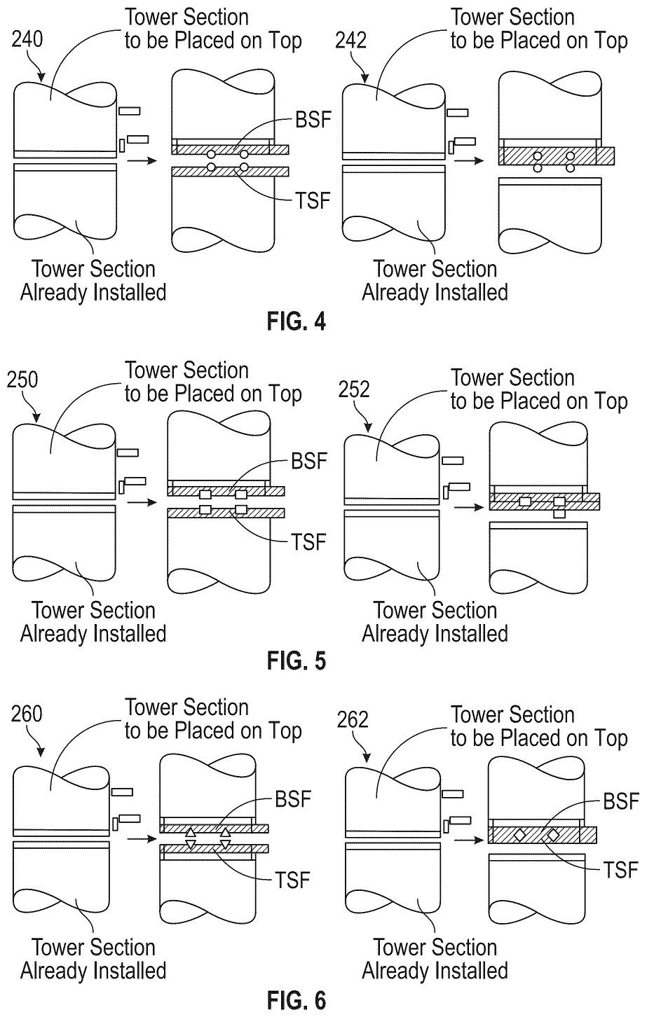

FIG. 4 illustrates a schematic diagram of a tower intermediate flange system with non-interference loading supports (with multiple or single), in accordance with an embodiment. In FIG. 4, the Bottom Support Flange (BSF) can be provided as an insert that can be located at the bottom of the top OEM upper tower section, and which can fit the design of the top OEM tower original flange, while also allowing for connection to/from the rack. The Top Support Flange (TSF) can be an insert that can be located at the top of the lower tower OEM section, and which can fit the design of the lower OEM tower section original flange and allow for connection to/from the rack. The compound sample shape produced by the upper and lower support flange can be a cylinder or similar shape, as indicated in the sequence shown in FIG. 4 in configuration 240 for a multi-flange or configuration 242 for a single flange.

FIG. 5 illustrates a schematic diagram of a tower intermediate flange system with non-interference loading supports (with multiple or single), in accordance with an embodiment. In FIG. 5, the Bottom Support Flange (BSF) can be an insert that can be located at the bottom of the top OEM upper tower section, and which can fit the design of the top OEM tower original flange and can also allow for connection to/from the rack. The Top Support Flange (TSF) can be an insert that is located at the top of the lower tower OEM section and can fit the design of the lower OEM tower section original flange, while allowing for connection to/from the rack. The compound shape produced by the upper and lower support flange can be a cuboid or similar shape, as indicated in the sequence shown in FIG. 5 in configuration 250 for a multi-flange or configuration 252 for a single flange.

FIG. 6 illustrates a schematic diagram of tower intermediate flange system with non-interference loading supports (with multiple or single), in accordance with an embodiment. In FIG. 6, the Bottom Support Flange (BSF) is an insert that can be located at the bottom of the top OEM upper tower section and can fit the design of the top OEM tower original flange, while also allowing for connection to/from the rack. The Top Support Flange (TSF) is an insert that is located at the top of the lower tower OEM section, will fit the design of the lower OEM tower section original flange, and will allow for connection to/from the rack. The compound shape produced by the upper and lower support flange is a rhomboid or similar, as indicated in the sequence shown in FIG. 6 in configuration 260 for multi flange or configuration 262 for single flange.

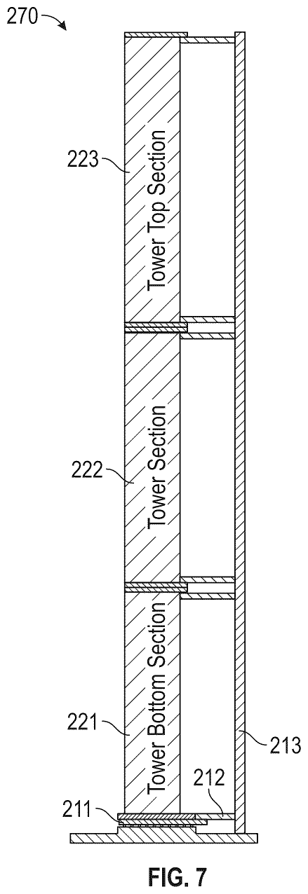

FIG. 7 illustrates a schematic diagram of a side view of a complete tower 270, in accordance with an embodiment. The tower 270 as completed can include the tower bottom section 221, the tower section 222, and the tower top section 223.

Based on the foregoing, it can be appreciated that a number of different embodiments are disclosed herein. For example, in an embodiment, a method of assembling a wind tower, can involve: providing a plurality of tower sections for a wind tower, wherein the plurality of tower sections includes a tower section and a previous tower section; and stacking the tower section over the previous tower section using at least one lower supported tower lift.

An embodiment can further involve adding at least one intermediate flange among a plurality of flanges at a top and a bottom of each tower section among the plurality of tower sections without permanently modifying existing components of the wind tower or using an OEM existing connection point.

In an embodiment, at least one flange among the plurality of flanges can be configured with indentations of variable shaped holes that can facilitate the handling of a weight into position and removal of a lifting system without pinch points.

An embodiment can further involve providing a plurality of flanges of different diameters and shapes, as well as different hole diameters and hole shapes that can facilitate lifting of the plurality of flanges.

An embodiment can further involve providing a configuration used in at least one flange among the plurality of flanges that becomes an integral part of original tower flanges for minimizing parts.

An embodiment can further involve using the configuration in assemblies with an external elevator, an internal elevator or a lifting system.

In an embodiment, a system for assembling a wind tower, can include: a plurality of tower sections for a wind tower, wherein the plurality of tower sections includes a tower section and a previous tower section, and at least one lower supported tower lift for stacking the tower section over the previous tower section using the at least one lower supported tower lift.

In an embodiment, at least one intermediate flange can be added at the top and the bottom of each tower section among the plurality of tower sections without permanently modifying existing components of the wind tower or using an OEM existing connection point.

In an embodiment, at least one flange can include indentations of variable shaped holes that facilitates handling of a weight into position and a removal of a lifting system without pinch points.

An embodiment can further include a plurality of flanges of different diameters and shapes, as well as different hole diameters and hole shapes that can assist in facilitating lifting of the plurality of flanges.

An embodiment can further include a configuration used in at least one flange among the plurality of flanges that can become an integral part of original tower flanges for minimizing parts.

In an embodiment, the configuration can be adapted for use in assemblies using an external elevator, an internal elevator, or a lifting system.

In an embodiment, a system for assembling a wind tower, can include: a plurality of tower sections for a wind tower, wherein the plurality of tower sections includes a tower section and a previous tower section; at least one lower supported tower lift for stacking the tower section over the previous tower section using the at least one lower supported tower lift; and a plurality of flanges.

In an embodiment, the plurality of flanges can include at least one intermediate flange.

In an embodiment, the at least one intermediate flange can be added at a top and a bottom of each tower section among the plurality of tower sections without permanently modifying existing components of the wind tower or using an OEM existing connection point.

In an embodiment, the plurality of flanges can include at least one flange comprising indentations of variable shaped holes that allow for a handling of a weight into position and for removal of a lifting system without pinch points.

In an embodiment, the plurality of flanges can include flanges of different diameters and shapes.

In an embodiment, the plurality of flanges can further include different hole diameters and hole shapes to facilitate lifting of the plurality of flanges.

In an embodiment, the plurality of tower sections of the wind tower further can include an intermediate tower section located between the tower section and the previous tower section.

In an embodiment, the plurality of flanges can include one or more of: a Bottom Support Flange (BSF) and a Top Support Flange (TSF).

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A method of assembling a wind tower, comprising:
providing a plurality of tower sections for a wind tower, wherein the plurality of tower sections includes a tower section and a previous tower section;
stacking the tower section over the previous tower section using at least one lower supported tower lift.

2. The method of claim 1 further comprising:
adding at least one intermediate flange among a plurality of flanges at a top and a bottom of each tower section among the plurality of tower sections without permanently modifying existing components of the wind tower or using an OEM existing connection point.

3. The method of claim 2 wherein at least one flange among the plurality of flanges includes indentations of variable shaped holes that facilitate handling of a weight into position and removal of a lifting system without pinch points.

4. The method of claim 1 further comprising:
providing a plurality of flanges of different diameters and shapes, as well as different hole diameters and hole shapes to facilitate lifting of the plurality of flanges.

5. The method of claim 1 further comprising:
providing a configuration used in at least one flange among the plurality of flanges that becomes an integral part of original tower flanges for minimizing parts.

6. The method of claim 5 further comprising:
using the configuration in assemblies using an external elevator, an internal elevator or a lifting system.

7. A system for assembling a wind tower, comprising:
a plurality of tower sections for a wind tower, wherein the plurality of tower sections includes a tower section and a previous tower section;
at least one lower supported tower lift for stacking the tower section over the previous tower section using the at least one lower supported tower lift.

8. The system of claim 7 further comprising:
at least one intermediate flange added at a top and a bottom of each tower section among the plurality of tower sections without permanently modifying existing components of the wind tower or using an OEM existing connection point.

9. The system of claim 8 wherein at least one flange includes indentations of variable shaped holes that facilitates handling of a weight into position and a removal of a lifting system without pinch points.

10. The system of claim 7 further comprising:
a plurality of flanges of different diameters and shapes, as well as different hole diameters and hole shapes to facilitate lifting of the plurality of flanges.

11. The system of claim 10 further comprising:
a configuration used in at least one flange among the plurality of flanges that becomes an integral part of original tower flanges for minimizing parts.

12. The system of claim 11 wherein the configuration is adapted for use in assemblies using an external elevator, an internal elevator, or a lifting system.

13. A system for assembling a wind tower, comprising:
a plurality of tower sections for a wind tower, wherein the plurality of tower sections includes a tower section and a previous tower section;
at least one lower supported tower lift for stacking the tower section over the previous tower section using the at least one lower supported tower lift; and
a plurality of flanges.

14. The system of claim 13 wherein the plurality of flanges include at least one intermediate flange.

15. The system of claim 14 wherein the at least one intermediate flange is added at a top and a bottom of each tower section among the plurality of tower sections without permanently modifying existing components of the wind tower or using an OEM existing connection point.

16. The system of claim 14 wherein the plurality of flanges includes at least one flange comprising indentations of variable shaped holes that allow for a handling of a weight into position and for removal of a lifting system without pinch points.

17. The system of claim 14 wherein the plurality of flanges comprises flanges of different diameters and shapes.

18. The system of claim 15 wherein the plurality of flanges further comprises different hole diameters and hole shapes to facilitate lifting of the plurality of flanges.

19. The system of claim 14 wherein the plurality of tower sections of the wind tower further includes an intermediate tower section located between the tower section and the previous tower section.

20. The system of claim 14 wherein the plurality of flanges further includes at least one of: a Bottom Support Flange (BSF) and a Top Support Flange (TSF).
